(19) United States
(12) Patent Application Publication
(10) Pub. No.: US 2009/0049434 A1
(43) Pub. Date: Feb. 19, 2009

(54) PROGRAM TRANSLATING APPARATUS AND COMPILER PROGRAM

(75) Inventor: Kenjiro Kawano, Miyazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/142,815

(22) Filed: Jun. 20, 2008

(30) Foreign Application Priority Data
Aug. 14, 2007 (JP) 2007-211289

(51) Int. Cl. G06F 9/28

(52) U.S. Cl. 717/149

(57) ABSTRACT

A program translating apparatus and compiler program of this invention translates program source code into intermediate code containing multiple instructions, extracts at least one combination of two parallelization candidate instructions from the intermediate code, extracts, for each parallelization candidate instruction, a dependency related instruction having a dependency relation with the parallelization candidate instruction from the intermediate code, determines, for each parallelization candidate instruction, a movement-feasible range for the parallelization candidate instruction based on the execution position of the extracted dependency related instruction for the parallelization candidate instruction, moves the two parallelization candidate instructions to an execution position contained in the common movement-feasible range of the two parallelization candidate instructions, thereby modifying the intermediate code, and translates it into instruction code.

### BACKGROUND OF THE INVENTION

1. Field of the Invention

The present invention relates to a program translating apparatus and compiler program for translating source code written in a program language such as the C language into instruction code executable by a computer.

2. Description of the Related Background Art

In these years, for the processors of computers, an architecture, which has an address generating set and an operation executing set as separate entities, is becoming used. In the architecture, for example, a transfer instruction and an operation instruction can be executed in parallel. Assuming that the number of execution cycles of an instruction is one, conventionally it takes two cycles to execute the transfer instruction and the operation instruction, but with an address generating set and an operation executing set as separate entities, execution time can be reduced to one cycle by replacing the transfer instruction and the operation instruction with a simultaneous or parallel execution instruction.

In translating source code written in the C language into instruction code including transfer instructions, operation instructions, etc., with use of a C compiler, which is software, intermediate code is once generated from the source code and various optimizations are performed on the generated intermediate code, thereafter finally generating instruction code. At this time, as to the parallel execution instruction mentioned above, the C compiler converts two instructions in the intermediate code into one parallel execution instruction. For such a program translating technique for parallelization at intermediate code level, Japanese Patent Application Laid-Open Publication No. 2001-282549 is referenced.

However, the conventional method has the fault that, in an attempt to move two instructions that are parallelization candidates to a simultaneous execution position, if another instruction in a dependency relation with these instructions exists in between them, these instructions are invariantly determined to be not movable, thus not parallelizing them. The dependency relation refers to the relation where, for example, a subsequent instruction references data or a flag updated by a previously executed instruction, and as such, a condition for executing a certain instruction becomes the execution result of a preceding instruction, or the execution result of a certain instruction becomes a condition for executing a subsequent instruction. If such a relation exists, the instruction order in which to execute instructions is subject to restriction.

FIGS. 1A and 1B show a specific example where because a dependency relation exists, instructions cannot be moved. Here the following intermediate quasi-instructions are used for description. That is, INSTPn, where n is a number assigned in order of instructions, is an instruction that can be subject to parallelization, and it is meant that, for example, INSTP1 and INSTP2 are parallelizable. INSTNn is an instruction that cannot be subject to parallelization. Following an instruction, another instruction being specified in the parentheses (i.e., ( )) indicates that there is the dependency relation between this instruction and another instruction. The instructions in the figure are executed in downward order.

Referring to FIG. 1A, there are dependency relations between INSTN1 and INSTP5; INSTP2 and INSTN4; INSTN3 and INSTP5; INSTN4 and INSTP2; and, INSTP5 and INSTN1, INSTN3. The two instructions, INSTP2 and INSTP5, are parallelizable.

In this case, an attempt to move INSTP2 and INSTP5 to a simultaneous execution position is made, but it is determined that INSTP2 cannot be moved to the position of INSTP5 because of its dependency relation with INSTN4, and that INSTP5 cannot be moved to the position of INSTP2 because of its dependency relation with INSTN3. As a result, INSTP2 and INSTP5 are not parallelized, and thus instruction execution is not made faster.

Referring to FIG. 1B, there are dependency relations between INSTN1 and INSTP5; INSTP2 and INSTN3; INSTN3 and INSTP2; INSTN4 and INSTP5; and, INSTP5 and INSTN1, INSTN4. The two instructions, INSTP2 and INSTP5, are parallelizable.

In this case, an attempt to move INSTP2 and INSTP5 to a simultaneous execution position is made, but it is determined that INSTP2 cannot be moved to the position of INSTP5 because of its dependency relation with INSTN3, and that INSTP5 cannot be moved to the position of INSTP2 because of its dependency relation with INSTN4. As a result, also in this case, INSTP2 and INSTP5 are not parallelized. As in the above specific example, with the conventional method of execution position parallelization, execution speed is not made higher enough.

### SUMMARY OF THE INVENTION

An object of the present invention is to provide a program translating apparatus and compiler program for making instruction execution faster to a maximum extent.

According to the present invention, there is provided a program translating apparatus which translates program source code into instruction code. The program translating apparatus comprises intermediate code generating means to translate the program source code into intermediate code containing multiple instructions; parallelization candidate instruction extracting means to extract at least one combination of two parallelization candidate instructions from the intermediate code; dependency related instruction extracting means to extract, for each parallelization candidate instruction, a dependency related instruction having a dependency relation with the parallelization candidate instruction from the intermediate code; movement-feasible range determining means to determine, for each parallelization candidate instruction, a movement-feasible range for the parallelization candidate instruction based on the execution position of the extracted dependency related instruction for the parallelization candidate instruction; and instruction code generating means to move the two parallelization candidate instructions to an execution position contained in the common movement-feasible range of the two parallelization candidate instructions, thereby modifying the intermediate code, and translate the modified intermediate code into the instruction code.

According to the present invention, there is provided a compiler program for allowing a computer to function as means to translate program source code into instruction code. The means includes intermediate code generating means to translate the program source code into intermediate code containing multiple instructions; parallelization candidate instruction extracting means to extract at least one combination of two parallelization candidate instructions from the intermediate code; dependency related instruction extracting means to extract, for each parallelization candidate instruction, a dependency related instruction having a dependency relation with the parallelization candidate instruction from the intermediate code; movement-feasible range determining means to determine, for each parallelization candidate instruction, a movement-feasible range for the parallelization candidate instruction based on the execution position of the extracted dependency related instruction for the parallelization candidate instruction; and instruction code generating means to move the two parallelization candidate instructions to an execution position contained in the common movement-feasible range of the two parallelization candidate instructions, thereby modifying the intermediate code, and translate the modified intermediate code into the instruction code.

According to the apparatus and compiler of this invention, more elaborate execution position parallelization of the instruction code is achieved, thus making instruction execution faster to a maximum extent.

### BRIEF DESCRIPTION OF THE DRAWINGS

FIG. 1A and 1B show a specific example of parallelization of instruction executions according to a conventional method;

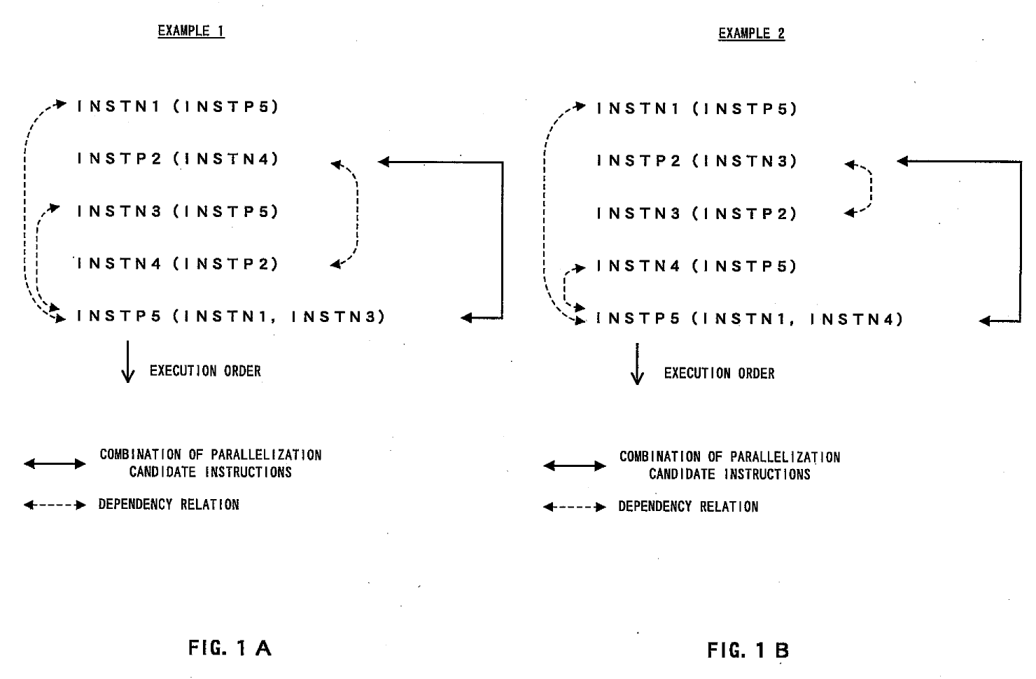

FIG. 2 is a block diagram showing the entire configuration of a program translating apparatus of a first embodiment;

FIG. 3 shows a setting example of the parallelizable instruction table of FIG. 2;

FIG. 4 is a flow chart showing a parallelization procedure in the first embodiment;

FIGS. 5A and 5B illustrate the way that instructions are moved in the procedure of FIG. 4;

FIG. 6 is a flow chart showing a parallelization procedure in the second embodiment;

FIG. 7A shows an example instruction arrangement as a premise for illustrating the procedure of FIG. 6;

FIG. 7B illustrates the way that instructions are moved in a set in the procedure of FIG. 6; and

FIG. 8 shows an actual example of parallelization obtained by executing the procedure of FIG. 6.

### DETAILED DESCRIPTION OF THE PREFERRED EMBODIMENTS

A first embodiment according to the present invention will be described in detail below with reference to the accompanying drawings.

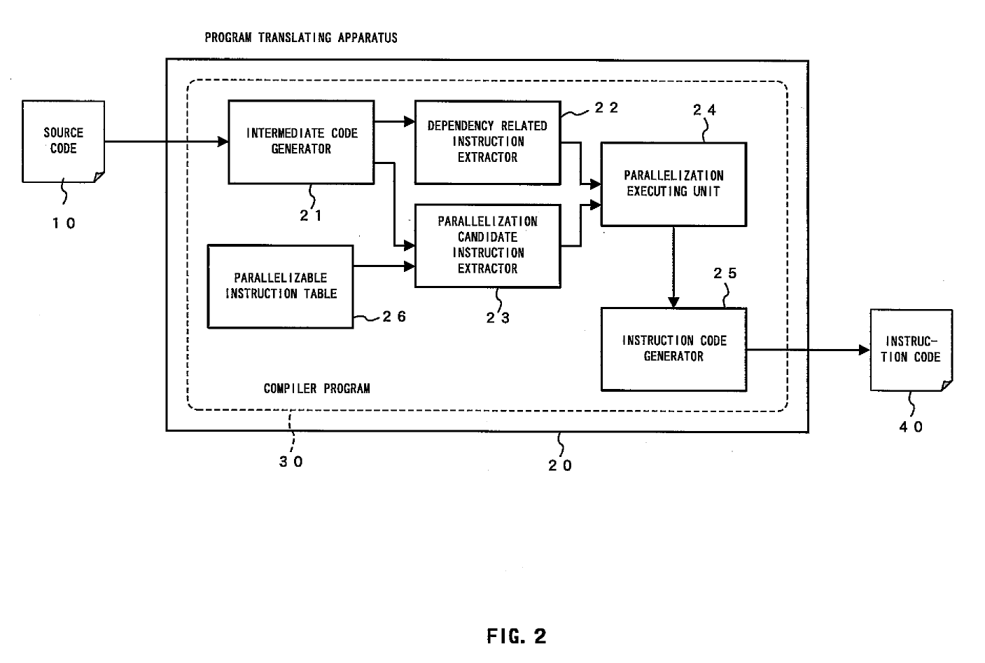

FIG. 2 shows the entire configuration of a program translating apparatus of the first embodiment. A program translating apparatus 20 takes in source code 10 as an input, translates the source code into instruction code 40, and outputs it. The source code 10 is data of source code written in a program language such as the C language and is taken in by the program translating apparatus 20 via various means such as a communication network and a record medium. The instruction code 40 is data of instruction code executable by a target computer, and is output to the computer via various means such as a communication network and a record medium. In the present embodiment, it is taken as a premise that the computer executing the instruction code 40 is a computer that comprises a processor of a parallel architecture having an address generating set and an operation executing set as separate entities to be capable of executing multiple instructions in parallel.

The program translating apparatus 20 comprises an intermediate code generator 21, a dependency related instruction extractor 22, a parallelization candidate instruction extractor 23, a parallelization executing unit 24, an instruction code generator 25, and a parallelizable instruction table 26. These components 21 to 26 may be embodied as a compiler program 30 with the program translating apparatus 20 as a computer.

The intermediate code generator 21 has a function to generate intermediate code from the taken-in source code 10 and supply the generated intermediate code to the dependency related instruction extractor 22 and the parallelization candidate instruction extractor 23. If data of the source code 10 is written in the C language, the intermediate code may be written in, e.g., an assembler language.

The dependency related instruction extractor 22 has a function to examine dependency relations between instructions based on the supplied intermediate code, extract a dependency related instruction for each instruction, and notify the dependency relations to the parallelization executing unit 24. The parallelization candidate instruction extractor 23 has a function to extract combinations of parallelization candidate instructions that can be executed simultaneously or parallelized from the supplied intermediate code and notify the extracted combinations to the parallelization executing unit 24. It is determined whether a certain instruction and another instruction are parallelizable by referencing the parallelizable instruction table 26, in which combinations of parallelizable instructions are set in advance.

The parallelization executing unit 24 has a function to identify the position to move two parallelization candidate instructions to, based on the dependency relations notified from the dependency related instruction extractor 22 and the parallelization candidate instructions notified from the parallelization candidate instruction extractor 23, and then execute parallelization on the intermediate code. The instruction code generator 25 has a function to finally generate instruction code from the intermediate code parallelized by the parallelization executing unit 24 by usual compiler processing.

The program translating apparatus 20 may be embodied by a computer such as a personal computer. In this case, the intermediate code generator 21, the dependency related instruction extractor 22, the parallelization candidate instruction extractor 23, the parallelization executing unit 24, and the instruction code generator 25, which form the compiler program 30, allow the program translating apparatus 20 to function as a computer.

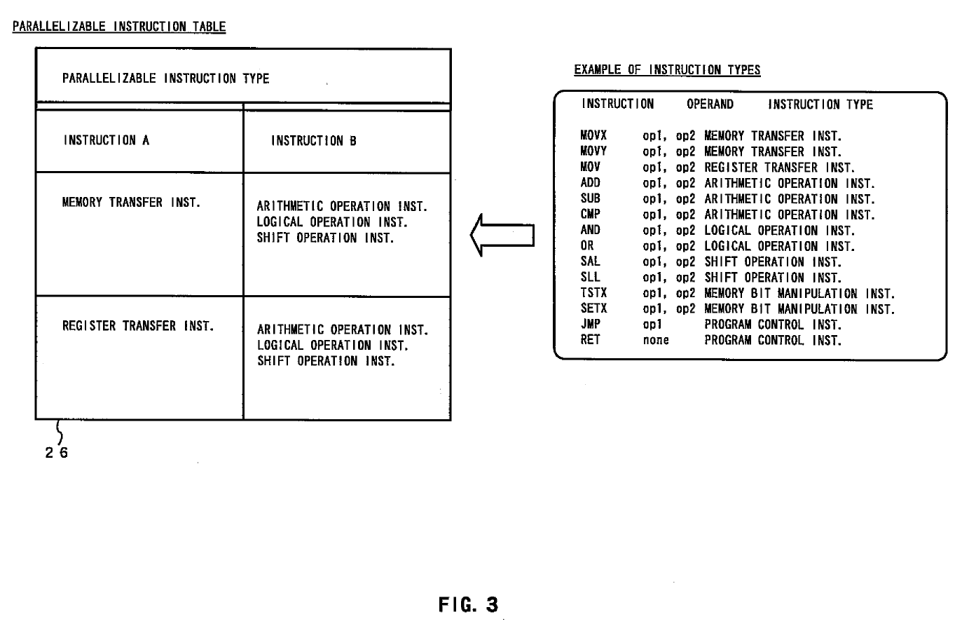

FIG. 3 shows a setting example of the parallelizable instruction table of FIG. 2. As shown in the figure, in the parallelizable instruction table 26, for example, a memory transfer instruction in the instruction A column and one of an arithmetic operation instruction, a logical operation instruction, and a shift operation instruction in the instruction B column are set to be parallelizable. As an example of the types of instructions, representations in an assembler language are shown on the right in the figure.

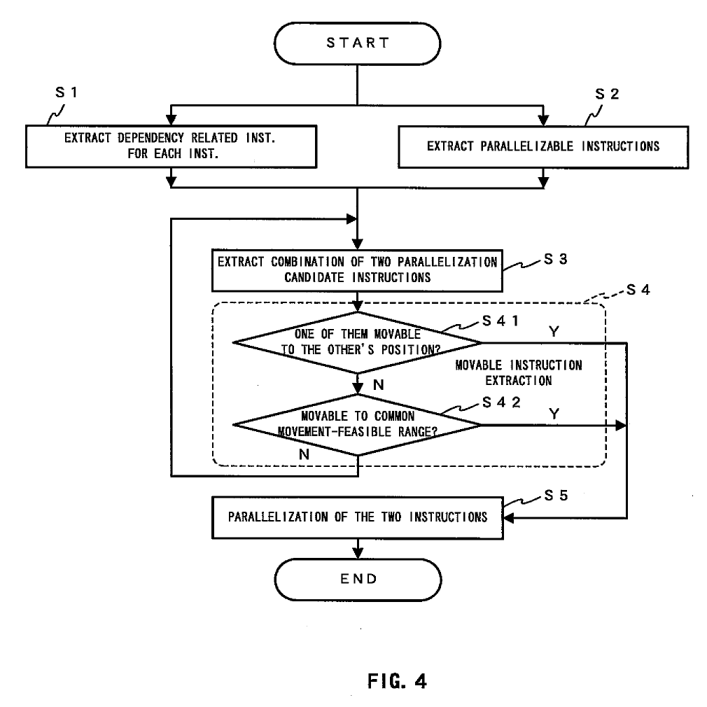

FIG. 4 shows a parallelization procedure in the first embodiment. It is taken as a premise that the source code has been input to the program translating apparatus and already translated into the intermediate code by the intermediate code generator 21 thereof (see FIG. 2). This parallelization procedure is executed by the dependency related instruction extractor, the parallelization candidate instruction extractor, and the parallelization executing set included in the program translating apparatus (see FIG. 2).

First, a dependency related instruction for each instruction is extracted from the intermediate code (step S1). Here a dependency related instruction refers to an instruction having a dependency relation where it precedes a certain instruction to give a condition for executing that instruction, or to an instruction having a dependency relation where it is subsequent to a certain instruction to depend on the execution result of that instruction.

In parallel with or subsequent to step S1, combinations of parallelizable instructions are extracted from the intermediate code (step S2). Whether instructions are parallelizable is determined by referencing the parallelizable instruction table to determine whether they are a combination of parallelizable instructions. Then, a combination of two parallelization candidate instructions to be parallelized is extracted from among the combinations of parallelizable instructions (step S3). That is, a combination of two instructions that do not have any dependency relations between them is extracted from among the combinations of parallelizable instructions.

Next, a movable one of the two instructions is determined (step S4). To be specific, a movable instruction is determined by determining whether one of the two instructions is movable to the position of the other one (step S41). At this time, if no dependency related instruction for an instruction to be moved exists in between the execution positions of the two instructions, the instruction to be moved is determined to be movable to the position of the other one. Then, parallelization at step S5 is performed in the same way as in the conventional method.

In contrast, if neither is determined to be movable, it is determined whether the two instructions are movable to within their common movement-feasible range (step S42). That is, for each of the two instructions, the movement-feasible range is determined from the execution position of the dependency related instruction(s) of that instruction. The movement-feasible range of an instruction refers to a range of from the execution position next to the dependency related instruction preceding that instruction to the execution position immediately before the dependency related instruction subsequent to that instruction. Then, the overlap position range of the movement-feasible ranges of the two instructions, i.e., the common movement-feasible range is extracted. If there are multiple overlap position ranges, extraction may end when one such position is extracted. If a common movement-feasible range exists, for example, the starting position of that common movement-feasible range is selected for parallelization (step S5). On the other hand, if no common movement-feasible range exists, the two instructions are determined to be not parallelizable, and the process returns to step S3, which extracts other two parallelization candidate instructions again.

In the parallelization at step S5, one of the two instructions is moved to the position of the other, or the two instructions are both moved to the same position within the common movement-feasible range, thereby realizing parallelization (step S5). The above parallelization procedure is executed for all the intermediate code in process, and the intermediate code modified by the parallelization is translated into instruction code by the instruction code generator.

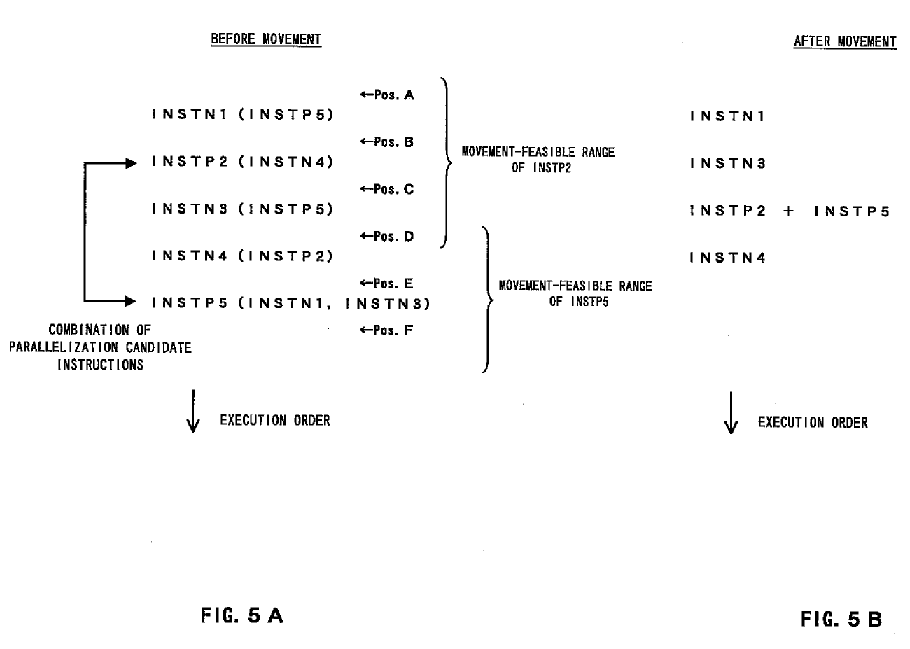

FIGS. 5A and 5B illustrate the way that instructions are moved in the procedure of FIG. 4. Referring to FIG. 5A, INSTP2 and INSTP5 are a combination of two parallelizable candidate instructions identified by steps S1 to S3 of FIG. 4. However, INSTP2 cannot move to the position of INSTP5 because of its dependency relation with INSTN4. Also, INSTP5 cannot move to the position of INSTP2 because of its dependency relation with INSTN3. Hence, the extraction of the common movement-feasible range (step S42) has to be executed.

Referring to FIG. 5B, position identifying names are marked for description of the above specific example. The movement-feasible range of INSTP2 is the range of from position A to position D in this example, and the movement-feasible range of INSTP5 is the range of from position D to position F. Hence, the overlap range of the movement-feasible ranges of INSTP2 and INSTP5 is determined to be position D. Thus, parallelization can be carried out by moving both the instructions to position D that is the common movement-feasible position.

Even in the case where a dependency related instruction exists in between two instructions to be parallelized and where hence conventionally the instructions are determined to be not movable, thus not being parallelized, by applying the program translating apparatus and compiler program according to the present invention as in the first embodiment, parallelization can be carried out if the overlap movement-feasible range for the two instructions exists. By this means, a program execution is made faster to a maximum extent.

A second embodiment according to the present invention will be described in detail below with reference to the accompanying drawings.

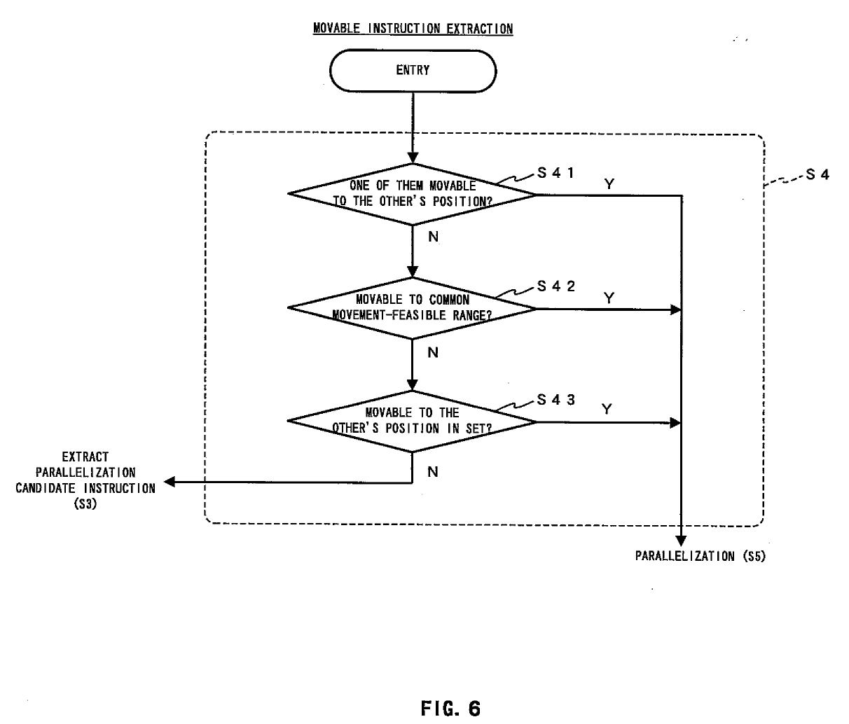

FIG. 6 shows a parallelization procedure in the second embodiment. In the second embodiment, a procedure different from that of the first embodiment is used with a program translating apparatus of the same configuration as in the first embodiment (see FIG. 2). That is, multiple instructions are moved in a unit comprising a set of instructions. With this method, in the movable instruction extraction of step S4 in the parallelization procedure of the first embodiment, if it is determined that neither of two parallelization candidate instructions is movable, the two instructions are parallelized by moving one of them together with instructions having dependency relations with the one in the set of those instructions.

Referring to FIG. 6, only the procedure of the movable instruction extraction is shown. It is taken as a premise that steps S1 to S3 of the first embodiment are already executed. That is, at least one combination of parallelization candidate instructions has been extracted.

Here it is determined whether one of the two parallelization candidate instructions is movable to the position of the other one as in the first embodiment (step S41). If neither is determined to be movable, it is determined whether the two instructions are movable to within their common movement-feasible range (step S42). If determined to be movable at either of steps S41 and S42, parallelization is executed at step S5.

On the other hand, if it is determined at step S42 that no common movement-feasible range exists, it is determined whether one of the two instructions is movable to the position of the other in a set of instructions (step S43). If determined to be not movable in a set, the process gives up the parallelization of the two instructions and returns to step S3, which extracts other parallelization candidate instructions again. In contrast, if determined to be movable in a set, in order to perform the parallelization of the two instructions in the set, parallelization at step S5 is executed. A specific example thereof will be described below.

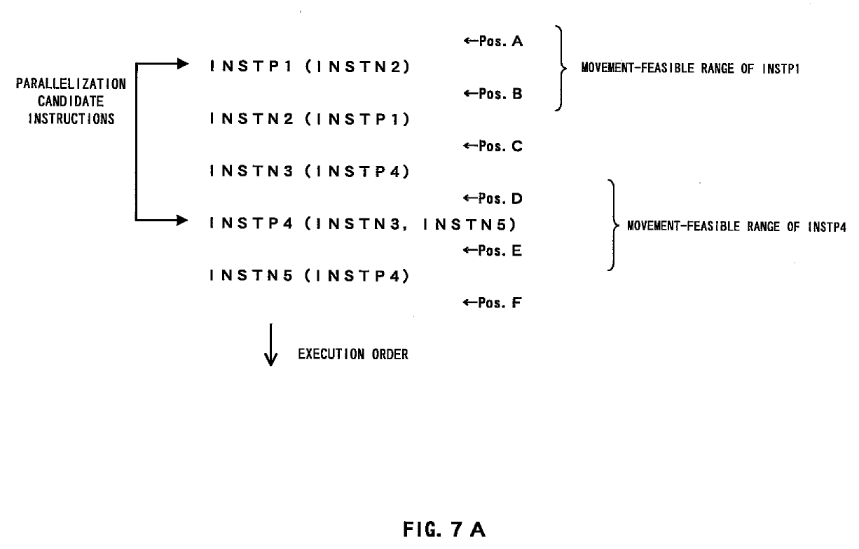

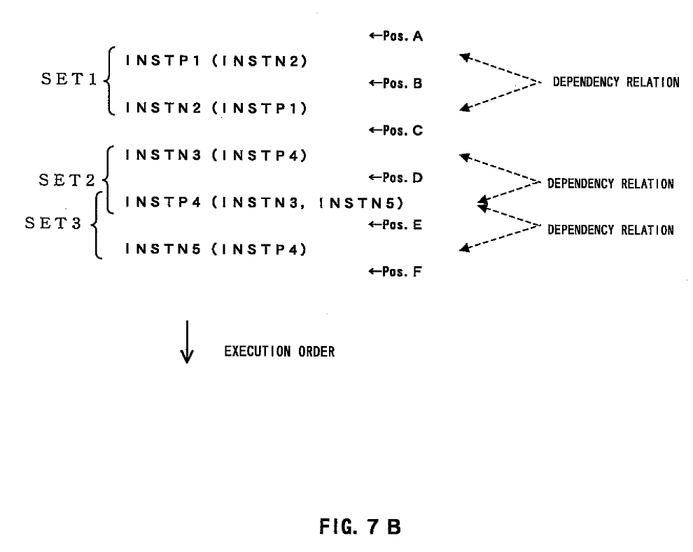

As shown in FIG. 7A, it is taken as a premise that INSTP1 and INSTP4 are a combination of two parallelization candidate instructions already extracted in steps preceding step S4. The movement-feasible range of INSTP1 is the range of from position A to position B, and the movement-feasible range of INSTP4 is the range of from position D to position E. Hence, the overlap range of the movement-feasible ranges of INSTP1 and INSTP4 does not exist, and thus it is determined that parallelization by movement to the common movement-feasible position of the two instructions is not possible.

As shown in FIG. 7B, a set of instructions is identified according to the dependency relations of each of INSTP1 and INSTP4. A set 1 of INSTP1 and INSTN2 in a dependency relation between them, a set 2 of INSTP4 and INSTN3 in a dependency relation between them, and a set 3 of INSTP4 and INSTN5 in a dependency relation between them are identified. Then, a movement candidate position for the parallelization of INSTP1 and INSTP4 is identified for each set. For making INSTP1 and INSTP4 be at the same execution position, the movement candidate position for the set 1 is position E, and the movement candidate position for the set 2 is position A, and the movement candidate position for the set 3 is position B.

Next, it is determined whether each set is movable to its movement candidate position by examining for each instruction of each set whether an instruction having a dependency relation with the instruction exists in any other sets different from the instruction's set, positioned in between the instruction's position and its movement candidate position.

By examining the set 1, because no dependency related instruction exists in between the position of INSTP1 or INSTN2 and position E, the set 1 is determined to be movable to position E. By examining the set 2, because no dependency related instruction exists in between the position of INSTN3 or INSTP4 and position A, the set 2 is determined to be movable to position A. By examining the set 3, because INSTN3, which is a dependency related instruction for INSTP4, exists in between the position of INSTP4 or INSTN5 and position B, the set 3 is determined to be not movable to position B. Thus, by moving the set 1 or 2, parallelization can be performed. In this case, for example, moving the set 1 to position E, which is determined earlier, is adopted to parallelize INSTP1 and INSTP4.

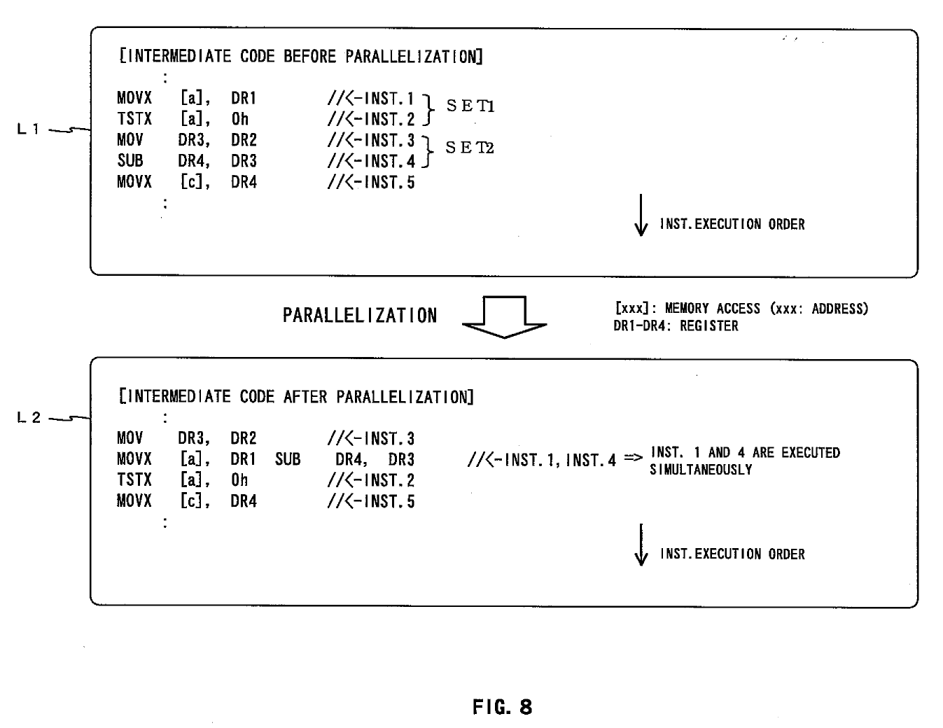

FIG. 8 shows an actual example of parallelization obtained by executing the procedure of FIG. 6. Referring to list L1, an example description of intermediate code before parallelization is shown. Here instruction MOVX (instruction 1) of the set 1 and instruction SUB (instruction 4) of the set 2 are parallelization candidate instructions. Referring to list L2, intermediate code after parallelizing the contents of list L1 is shown. Here instruction MOVX (instruction 1) and instruction SUB (instruction 4) are written laterally, and thus the instruction 1 and the instruction 4 will be executed simultaneously.

As described in the above second embodiment, even in the case where as in the first embodiment, no common movement-feasible range exists, hence not being parallelized, by applying the program translating apparatus and compiler program according to the present invention, parallelization can be carried out if a parallelization candidate instruction together with its dependency related instruction is movable in a set. By this means, parallelization is achieved to a further maximum extent.

In the above embodiments, examples where source code is written in the C language have been described, but not being limited to this, the source code may be written in various languages other than the C language. Further, although the instruction code has been described as instruction code that is supplied to a computer, the instruction code in the present invention need only be instruction code that is supplied to a processor of a parallel architecture and may be either of instruction code for personal computers or servers and instruction code for a DSP (Digital Signal Processor) that is incorporated in a specific functional device to realize a particular processing function.

What is claimed is:

1. A program translating apparatus which translates program source code into instruction code, comprising:
intermediate code generating means to translate said program source code into intermediate code containing multiple instructions;
parallelization candidate instruction extracting means to extract at least one combination of two parallelization candidate instructions from said intermediate code;
dependency related instruction extracting means to extract, for each said parallelization candidate instruction, a dependency related instruction having a dependency relation with the parallelization candidate instruction from said intermediate code;
movement-feasible range determining means to determine, for each said parallelization candidate instruction, a movement-feasible range for the parallelization candidate instruction based on the execution position of the extracted dependency related instruction for the parallelization candidate instruction; and
instruction code generating means to move said two parallelization candidate instructions to an execution position contained in the common movement-feasible range of said two parallelization candidate instructions, thereby modifying said intermediate code, and translate the modified intermediate code into said instruction code.

2. A program translating apparatus according to claim 1, wherein said dependency related instruction extracting means extracts, for each said parallelization candidate instruction, an instruction having a dependency relation where the instruction precedes the parallelization candidate instruction to give a condition for executing the candidate instruction, or an instruction having a dependency relation where the instruction is subsequent to the parallelization candidate instruction to depend on the execution result of the candidate instruction, as said dependency related instruction.

3. A program translating apparatus according to claim 1 or 2, wherein if said common movement-feasible range does not exists, said instruction code generating means moves at least one of said parallelization candidate instructions and a dependency related instruction corresponding to the one in the set of those instructions, thereby modifying said intermediate code.

4. A compiler program for allowing a computer to function as means to translate program source code into instruction code, said means including:
intermediate code generating means to translate said program source code into intermediate code containing multiple instructions;
parallelization candidate instruction extracting means to extract at least one combination of two parallelization candidate instructions from said intermediate code;
dependency related instruction extracting means to extract, for each said parallelization candidate instruction, a dependency related instruction having a dependency relation with the parallelization candidate instruction from said intermediate code;
movement-feasible range determining means to determine, for each said parallelization candidate instruction, a movement-feasible range for the parallelization candidate instruction based on the execution position of the extracted dependency related instruction for the parallelization candidate instruction; and
instruction code generating means to move said two parallelization candidate instructions to an execution position contained in the common movement-feasible range of said two parallelization candidate instructions, thereby modifying said intermediate code, and translate the modified intermediate code into said instruction code.

5. A compiler program according to claim 4, wherein said dependency related instruction extracting means extracts, for each said parallelization candidate instruction, an instruction having a dependency relation where the instruction precedes the parallelization candidate instruction to give a condition for executing the candidate instruction, or an instruction having a dependency relation where the instruction is subsequent to the parallelization candidate instruction to depend on the execution result of the candidate instruction, as said dependency related instruction.

6. A compiler program according to claim 4 or 5, wherein if said common movement-feasible range does not exist, said instruction code generating means moves at least one of said parallelization candidate instructions and a dependency related instruction corresponding to the one in the set of those instructions, thereby modifying said intermediate code.
